(19) United States
(12) Patent Application Publication
(10) Pub. No.: US 2025/0102351 A1
(43) Pub. Date: Mar. 27, 2025

(54) METHOD FOR MONITORING A ROTATING MACHINE AND ASSOCIATED DEVICE AND SYSTEM

(71) Applicant: Aktiebolaget SKF, Göteborg (SE)

(72) Inventors: Patrik PÄÄJÄRVI, Södra Sunderbyn (SE); James P. LEBLANC, Luleå (SE); Anders LARSSON, Järfälla (SE)

(21) Appl. No.: 18/884,225

(22) Filed: Sep. 13, 2024

(30) Foreign Application Priority Data
Sep. 22, 2023 (DE) 102023209287.5

(51) Int. Cl. G01H 1/00; G01M 13/045

(52) U.S. Cl. CPC G01H 1/003; G01M 13/045

(57) ABSTRACT

A device (4) for monitoring a rotating machine (2) having a plurality of rotating parts (2a, 2b, 2c). The device (4) includes a first determining means (5), a selecting means (8), a second determining means (6), a third determining means (7), and an actuation means (10). The first determining means (5) determines the frequency spectrum of a measured vibration signal (S_{M}) of a plurality of spectral lines (C1-16). The selecting means (8) selects spectral lines (C1-16) according to a predetermined selection rule. The second determining means (6) determines the unidentified spectral lines. The third determining means (7) determines the waveform power of each unidentified spectral line. The actuation means (10) triggers an alarm if the determined power of at least one unidentified spectral line is equal to or bigger than a power threshold (γ).

### CROSS-REFERENCE TO RELATED APPLICATION

This application claims priority to German Application No. 102023209287.5, filed Sep. 22, 2023, the entirety of which is hereby incorporated by reference.

### FIELD

The present disclosure is directed to the monitoring of rotating machines.

More particularly, the present disclosure deals with a method and a device for monitoring a rotating machine, and a system comprising such a device.

### BACKGROUND

Generally, to detect a fault of a rotating machine, for example to diagnose bearing faults or imbalance, vibration analysis of the machine is performed.

Vibration analysis comprises a comparison of lines in the estimated frequency spectrum of vibration signals to a typically large number of reference frequencies predicted by a machine vibration model (MVM) or an environmental model (EM).

The vibration signals are generally delivered by a sensor on the rotating machine.

The MVM is derived from knowledge about the machine's physical construction and its shaft speeds, and the EM is derived from knowledge about the machine's surrounding environment.

The rotating machine's physical construction comprises for example the features of shaft couplings, bearing types, number of vanes in impellers, number and kind of gear tooth, and gear tooth counts.

When the frequency of a line in the estimated frequency spectrum coincides with a fault frequency as predicted by the MVM, the corresponding part is considered faulty.

If the MVM is inaccurate, for example producing incorrect reference frequencies, actual faults may go unnoticed when the corresponding vibration frequencies deviate from those predicted by the MVM model, potentially causing machine breakdown.

Alternatively, mistaking a benign vibration frequency for a fault frequency leads to unnecessary maintenance and production stops.

A cause leading to an inaccurate MVM is, for example, during maintenance when machine parts are replaced with dissimilar parts without updating the specifications of the rotating machine.

Another cause may be when commissioning a new vibration-based monitoring system on the rotating machine, the rotating machine specification data is often incomplete with unknown gear tooth counts and/or bearing types.

Furthermore, building the MVM from specifications or inspection of the rotating machine's physical construction is a manual and error-prone procedure.

A manual inspection of frequency spectra may be performed to detect anomalies and errors in the MVM or EM.

Such a manual inspection is resource-demanding and time consuming, and the result largely depends on the operator's awareness, knowledge about the machine and attention to details.

Consequently, the present disclosure proposes to improve the robustness of the MVM or EM by enhancing the detection of anomalies and errors in the MVM or EM to improve the reliability of vibration analysis of rotating machines.

### SUMMARY

According to an aspect, a method for monitoring a first model of a rotating machine including a plurality of rotating parts, and a second model of periodic external interferences, the first model comprising a first set of predicted spectral lines and the second model comprising a second set of predicted spectral lines, the method is proposed.

The method comprises:
measuring vibrations of the rotating machine to deliver a measured vibration signal,
determining the frequency spectrum of the measured vibration signal, the frequency spectrum comprising a plurality of spectral lines,
selecting spectral lines from the plurality of spectral lines according to a predetermined selection rule, the selected spectral lines being significant spectral lines,
determining the significant spectral lines which are not included in the first set of predicted spectral lines and in the second set of predicted spectral lines, the determined significant spectral lines being unidentified spectral lines,
determining the waveform power of each unidentified spectral line,
comparing the determined power of each unidentified spectral line to a power threshold, and
triggering an alarm if the determined power of at least one unidentified spectral line is equal to or bigger than the power threshold.

The method allows automatic detection of modelling errors of the first model and the second model to avoid catastrophic failures or unnecessary maintenance and production stops due to misclassification of spectral lines.

Automatic detection runs during normal operation which allows to preserve machine up-time.

The first model comprises a machine vibration model (MVM) and the second model comprises an environmental model (EM) of the rotating machine.

Preferably, determining the frequency spectrum of the measured vibration signal comprises performing a nonparametric method of spectral analysis or a parametric method of spectral analysis.

Advantageously, the predetermined selection rule comprises a model-order selection rule.

Preferably, determining the significant spectral lines which are not included in the first set of predicted spectral lines and in the second set of predicted spectral lines comprises:
for each significant spectral line and each rotating part and each periodic external interference, determining a likelihood function from the first model and the second model of the frequencies generated by the said rotating part in rotation and the frequencies of the second set of predicted spectral lines,
for each likelihood function, evaluating the said likelihood function at the frequency of each significant spectral line to obtain a likelihood probability under frequencies generated by the said rotating part in rotation and frequencies of the periodic external interferences,
for each likelihood probability, comparing the said likelihood probability to a classifying threshold,
when the said likelihood probability is smaller than the classifying threshold, the said significant spectral line is determined not to be included in the first set of predicted spectral lines and in the second set of predicted spectral lines.

Advantageously, when the likelihood probability is equal to or bigger than the classifying threshold, the said significant spectral line is assumed to be included in the first set of predicted spectral lines or in the second set of predicted spectral lines.

If one or more of the said significant spectral lines are determined to be included in neither the first set of predicted spectral lines nor and in the second set of predicted spectral lines, the first and second models are assumed to be not reliable.

Conversely, if all of the said significant spectral lines are determined to be included in either the first set of predicted spectral lines or in the second set of predicted spectral lines, the first and second models are assumed to be reliable.

Preferably, when for a rotating part, a prior probability that the frequencies generated by the said rotating part in rotation are included in the measured vibration signal is known and a prior probability that the frequencies of the second set of predicted spectral lines are included in the measured vibration signal is known, determining the significant spectral lines which are not included in the first set of predicted spectral lines and in the second set of predicted spectral lines comprises:
for each significant spectral line and each rotating part and each periodic external interference, determining a likelihood function from the first model and the second model of the frequencies generated by the said rotating part in rotation and the frequencies of the second set of predicted spectral lines,
for each likelihood function evaluating the said likelihood function at the frequency of each significant spectral line to obtain a likelihood probability under frequencies generated by the said rotating part in rotation and frequencies of the periodic external interferences,
determining a first probability that the frequency of the said significant spectral line is included in the measured vibration signal,
for each likelihood probability, determining a posterior probability generated by the said rotating part in rotation under the frequency of the said significant spectral line or the frequencies of the second set of predicted spectral lines, the posterior probability being equal to the said likelihood probability multiplied by the prior probability, the product of the multiplication being divided by the first probability,
when the said posterior probability is smaller than the classifying threshold, the said significant spectral is determined not be included in the first set of predicted spectral lines and in the second set of predicted spectral lines.

Advantageously, when the posterior probability is equal to or bigger than the classifying threshold, the said significant spectral line is assumed to be included in the first set of predicted spectral lines or in the second set of predicted spectral lines, the first and second models are assumed to be reliable.

Preferably, the likelihood function is a Gaussian mixture model having its modes centered at the frequencies generated by the said rotating part in rotation or a periodic external interference.

According to another aspect, a device for monitoring a first model of a rotating machine including a plurality of rotating parts and a second model of periodic external interferences, the first model comprising a first set of predicted spectral lines and the second model comprising a second set of predicted spectral lines, the device is proposed.

The device comprises:
first determining means configured to determine the frequency spectrum of a measured vibration signal, the frequency spectrum comprising a plurality of spectral lines, the measured vibration signal comprising measured vibrations of the rotating machine,
selecting means configured to select spectral lines from the plurality of spectral lines according to a predetermined selection rule, the selected spectral lines being significant spectral lines,
second determining means configured to determine the significant spectral lines which are not included in the first set of predicted spectral lines and in the second set of predicted spectral lines, the determined significant spectral lines being unidentified spectral lines,
third determining means configured to determine the waveform power of each unidentified spectral line,
comparing means configured to compare the determined power of each unidentified spectral line to a power threshold, and
actuation means configured to trigger an alarm if the determined power of at least one unidentified spectral line is equal to or bigger than the power threshold.

According to another aspect, a system comprising a rotating machine including a plurality of rotating parts, measuring means configured to measure vibrations of the rotating machine and to deliver a measured vibration signal, a first model of the rotating machine including a plurality of rotating parts, a second model of periodic external interferences and a device as defined above connected to the measuring means, the first model comprising a first set of predicted spectral lines and the second model comprising a second set of predicted spectral lines is proposed.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically an example of a system according to the present disclosure;

FIG. 2 illustrates schematically an example of a method for monitoring the rotating machine according to the present disclosure;

FIG. 3 illustrates schematically an example of the frequency spectrum of a measured vibration signal according to the present disclosure,

FIG. 4 illustrates schematically an example of significant spectral lines according to the present disclosure,

FIG. 5 illustrates schematically an example of a likelihood function according to the present disclosure, and

FIG. 6 illustrates schematically a graphic example of the comparison of unidentified spectral lines with the power threshold according to the present disclosure.

### DETAILED DESCRIPTION

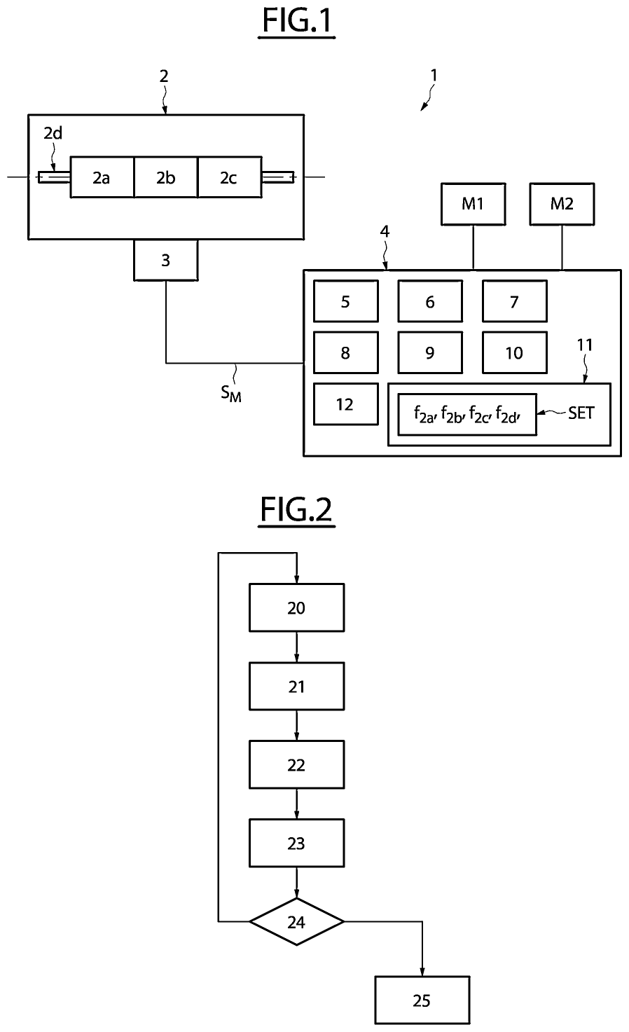

Reference is made to FIG. 1 which represents schematically a system 1 comprising a rotating machine 2, measuring means 3, a first model M1 of the rotating machine 2, a second model M2 of periodic external interferences and a device 4 for monitoring the first model M1 and the second model M2.

The first model M1 comprises a machine vibration model and the second model M2 comprises an environmental model of the rotating machine.

The machine 2 comprises a plurality of rotating parts 2a, 2b, 2c driven for example by a shaft 2d of the machine 2.

The rotating parts 2a, 2b, 2c may be shaft couplings, bearings, impellers.

The features of each rotating part 2a, 2b, 2c are known so that the frequency f₂ₐ, f_{2b}, f_{2c} generated by the rotation of the rotating part 2a, 2b, 2c is known or may be derived from its physical construction together with the speed of the shaft 2d.

The first model M1 comprises a first set of predicted spectral lines and the second model M2 comprises a second set of predicted spectral lines.

The second model M2 models periodic external interferences which may appear in measurements, for example electromagnetic interferences having frequencies f_{d} equal for example to 50 Hz or 100 Hz.

The periodic external interferences are generated by devices in the environment of the machine 2. The speed of the shaft 2d may be measured by a speed sensor and may have some variations.

Measuring means 3 are intended to measure vibrations of the machine 2 and to deliver a measured vibration signal S_{M} comprising vibrations to the device 4.

The measuring means 3 may comprise a vibration sensor.

A set SET of frequencies comprising the frequencies f₂ₐ, f_{2b}, f_{2c} generated by the rotation of the rotating parts 2a, 2b, 2c, the frequencies f_{d} of the periodic external interferences and their harmonics constitute an expected set of frequencies of the machine 1 to be found in vibration measurements assuming that the rotating machine's physical construction is accurately known.

The device 4 comprises first determining means 5, second determining means 6, third determining means 7, selecting means 8, comparing means 9, actuation means 10, a memory 11 storing the set SET and processing means 12.

The processing means 12 are intended to implement the first determining means 5, the second determining means 6, the third determining means 7, the selecting means 8, the comparing means 9, the actuation means 10 and the memory 11, and may comprise a processing unit.

FIG. 2 illustrates schematically an example of a method for monitoring the first model M1 and the second model M2 implementing the device 4.

During a step 20, the measuring means 3 measure vibrations of the machine 2 and deliver the measured vibration signal S_{M} including the measured vibrations.

During a step 21, the first determining means 5 determine the frequency spectrum of the measured vibration signal S_{M}.

The first determining means 5 may implement a non-parametric method of spectral analysis such as Fast Fourier Transform FFT or a parametric method of spectral analysis such as estimation of signal parameters via rotational invariant techniques ESPRIT or autoregressive models AR.

It is assumed in the following that the first determining means 5 implement a Fast Fourier Transform FFT algorithm.

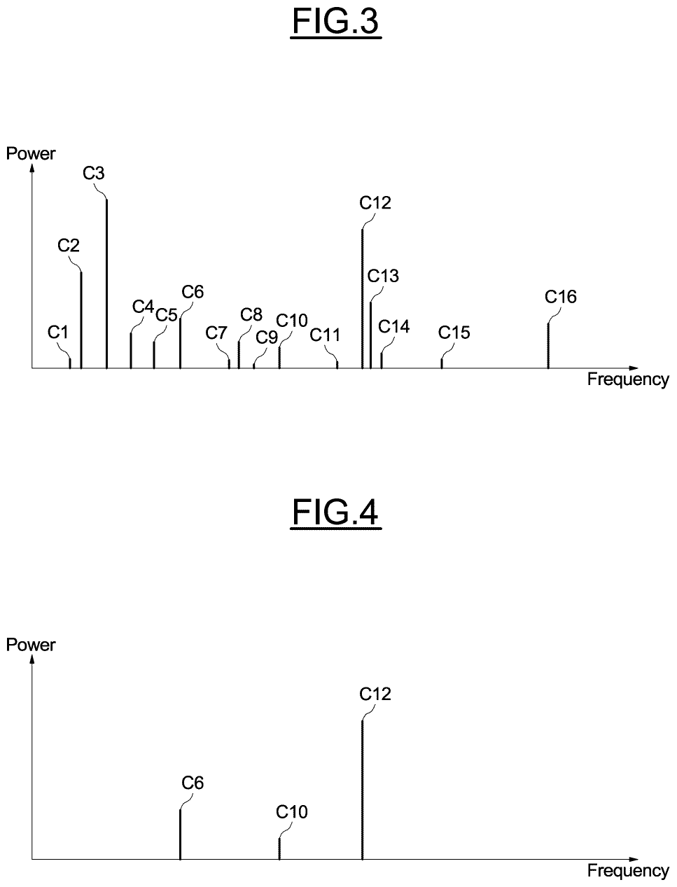

FIG. 3 illustrates schematically an example of the frequency spectrum of the measured vibration signal S_{M} determined by the first determining means 5.

The frequency spectrum comprises a plurality of spectral lines C1 to C16.

During a step 21, the selecting means 8 select spectral lines from the plurality of spectral lines according to a predetermined selection rule.

The selected spectral lines are significant spectral lines.

The predetermined selection rule may comprise a model-order selection rule, for example the Akaike information criterion as disclosed in the document “A new look at the statistical model identification”, IEEE Transactions on Automatic Control, 19 (6): 716-723, Akaike H. (1974).

FIG. 4 illustrates schematically an example of the significant spectral lines C6, C10, C12 determined by the selecting means 8 according to the frequency.

During a step 22, the second determining means 6 determine the significant spectral lines which are not included in the first set of predicted spectral lines of the first model M1 and in the second set of predicted spectral lines of the model M2.

The second determining means 6 implement a model-based hypothesis testing of the frequencies of the significant spectral lines.

The determined significant spectral lines are unidentified spectral lines.

A first method to determine the significant spectral lines which are not included in the first set of predicted spectral lines of the first model M1 and in the second set of predicted spectral lines of the model M2 is described.

The first method is implemented by the second determining means 6.

For each significant spectral line C6, C10, C12 and each rotating part 2a, 2b, 2c and each periodic external interference, the second determining means 6 determine a likelihood function p from the first model M1 and the second model M2 of the frequencies (f2a, f2b, f2c) generated by the said rotating part (2a, 2b, 2c) in rotation and the frequencies (f_{d}) of the second set of predicted spectral lines.

For each likelihood function p, the second determining means 6 evaluate the said likelihood function p at the frequency f_{C6}, f_{C10}, f_{C12} of the said significant spectral line C6, C10, C12 to obtain a likelihood probability under frequencies f₂ₐ, f_{2b}, f_{2c} generated by the said rotating part in rotation or frequencies f_{d} of the periodic external interferences.

The likelihood probability is noted p(f_{ci}|f₂ⱼ) (rotating parts) where i is equal to 6, 10, 12 and j is equal to a, b, c in this example or p(f_{ci}|f_{d}) (periodic external interferences).

For each likelihood probability, the second determining means 6 compare the said likelihood probability p(f_{ci}|f₂ⱼ) or p(f_{ci}|f_{d}) to a classifying threshold t.

The classifying threshold τ is chosen within the range (0,1), trading off the risk of a false alarm (small τ) to the risk of a missed detection (large τ).

When the said likelihood probability p(f_{ci}|f₂ⱼ) or p(f_{ci}|f_{d}) is smaller than the classifying threshold, the said significant spectral line is determined not to be included in the first set of predicted spectral lines or in the second set of predicted spectral lines, the first and second models are assumed to be reliable.

When the said likelihood probability p(f_{ci}|f₂ⱼ) or p(f_{ci}|f_{d}) is equal to or bigger than the classifying threshold τ, the said significant spectral line Ci is assumed to be included in the first set of predicted spectral lines or in the second set of predicted spectral lines, the first and second models are assumed to be reliable.

The likelihood function may be a Gaussian mixture model having its modes centered at the frequencies generated by the rotating part 2a, 2b, 2c in rotation or the periodic external interferences.

The frequencies generated by each rotating part 2a, 2b, 2c comprise the fundamental frequency f₂ₐ, f_{2b}, f_{2c} and their harmonics n. f₂ₐ, n.f_{2b}, n.f_{2c}, where n is an integer bigger than or equal to two.

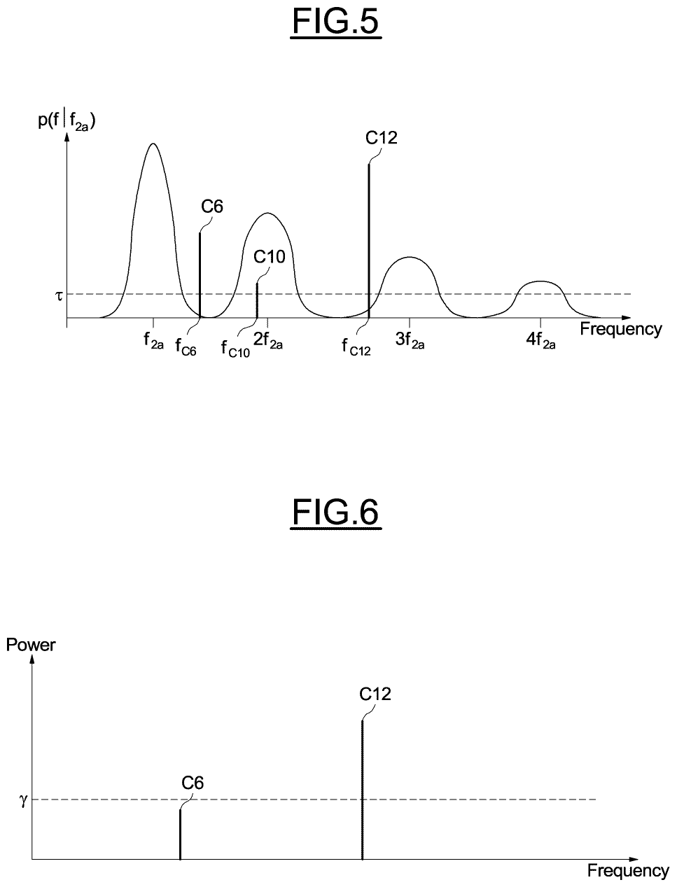

FIG. 5 illustrates schematically an example of the likelihood function p(f|f₂ₐ).

The value of the likelihood function p(f|f₂ₐ) is bigger than the classifying threshold τ for the significant spectral line C10 having the frequency f_{C10}.

The significant spectral line C10 is identified as a harmonic of the rotation frequency f₂ₐ of the rotating part 2a.

The significant spectral line C10 is assumed to be included in the first set of predicted spectral lines or in the second set of predicted spectral lines, the first and second models are assumed to be reliable.

The value of the likelihood function p(f|f₂ₐ) is smaller than the classifying threshold τ for the significant spectral lines C6, C12 having the frequencies f_{C6}, f_{C12}.

The significant spectral lines C6, C12 are determined not to be included in the first set of predicted spectral lines and in the second set of predicted spectral line.

A second method implemented by the second determining means 6 to determine the significant spectral lines which are not which are not included in the first set of predicted spectral lines of the first model M1 and in the second set of predicted spectral lines of the model M2.

The second method is implemented by the second determining means 6.

The second method is implemented when for a rotating part 2a, 2b, 2c a prior probability p(f₂ⱼ) that the frequencies generated by the said rotating part in rotation, and a prior probability p(f_{d}) that the frequencies of the second set of predicted spectral lines are included in the measured vibration signal is known.

The prior probabilities p(f₂ⱼ) may be selected based on experience or specific machine knowledge.

The second method adopts a Bayesian approach improving the average performance of vibration source classification.

It is assumed that the set of significant spectral lines includes the spectral lines C6, C10, C12 determined as defined above.

For each significant spectral line C6, C10, C12 and each rotating part 2a, 2b, 2c or periodic external interferences, the second determining means 6 determine the likelihood probability p(f_{ci}|f₂ⱼ) or p(f_{ci}|f_{d}) as defined above.

The second determining means 6 determine a first probability p(f_{ci}) that the frequency f_{ci} of the said significant spectral line C6, C10, C12 is included in the measured vibration signal S_{M}.

The second determining means 6 further determine a posterior probability p(f₂ⱼ|f_{ci}) of the frequency f₂ⱼ generated by the rotating part 2a, 2b, 2c in rotation under the frequency f_{c6}, f_{c10}, f_{c12} of the significant spectral line C6, C10, C12 or p(f_{d}|f_{ci}) of the frequencies f_{d} of the second set of predicted spectral lines.

The posterior probability p(f₂|f_{ci}) is equal to the likelihood probability p(f_{ci}|f₂ⱼ) multiplied by the prior probability p(f₂ⱼ), the product of the multiplication being divided by the first probability p(f_{ci}).

$$p ( {f}_{2 j} \vert {f}_{c i} ) = \frac{p ( {f}_{ci} \vert {f}_{2 j} ) p ( {f}_{2 j} )}{p ( {f}_{c i} )} \qquad ( 1 )$$

Or the posterior probability p(f_{d}|f_{ci}) is equal to the likelihood probability p(f_{ci}|f_{d}) multiplied by the prior probability p(f_{d}), the product of the multiplication being divided by the first probability p(f_{ci}).

$$p ( {f}_{d} \vert {f}_{c i} ) = \frac{p ( {f}_{c i} \vert {f}_{d} ) p ( {f}_{d} )}{p ( {f}_{c i} )} \qquad ( 2 )$$

The second determining means 6 compare the posterior probability p(f₂ⱼ|f_{ci}) or p(f_{d}|f_{ci}) to a classifying threshold τ.

When the posterior probability p(f₂ⱼ|f_{ci}) or p(f_{d}|f_{ci}) is smaller than the classifying threshold τ, the said significant spectral line Ci is determined not to be included in the first set of predicted spectral lines and in the second set of predicted spectral lines.

When the posterior probability p(f₂ⱼ|f_{ci}) or p(f_{d}|f_{ci}) is equal to or bigger than the classifying threshold τ, the said significant spectral line Ci is assumed to be included in the first set of predicted spectral lines or in the second set of predicted spectral lines, the first and second models are assumed to be reliable.

The likelihood function may be a Gaussian mixture model having its modes centered at the frequencies generated by the rotating part 2a, 2b, 2c in rotation or centered at the frequencies f_{d} of the periodic external interferences.

When the unidentified spectral lines C6, C12 are determined included in the first set of predicted spectral lines and in the second set of predicted spectral lines, in a step 23, the third determining means 7 determine the waveform power of each unidentified spectral line C6, C12.

The waveform power is determined by the third determining means 7 from the unidentified spectral line C6, C12 for example through sinusoid amplitude estimation when the frequency spectrum of the measured vibration signal S_{M} is determined with FFT or ESPRIT in step 21 or pole magnitude when the frequency spectrum of the measured vibration signal S_{M} is determined with AR in step 21.

The comparing means 9 compare the determined power of each unidentified spectral line C6, C12 to a power threshold γ.

The power threshold γ is chosen trading off the risk of a false alarm (small γ) to the risk of a missed detection (large γ).

FIG. 6 illustrates schematically a graphic example of the comparison of the unidentified spectral lines with the power threshold γ.

The waveform power of the unidentified spectral line C6 is smaller than the power threshold γ and the waveform power of the unidentified spectral line C12 is bigger than the power threshold γ.

As at least the waveform power of at least one unidentified spectral line C12 is bigger than the power threshold γ (step 24), in a step 25, the actuation means 10 trigger an alarm.

If the waveform power of the unidentified spectral line is smaller than the power threshold γ (step 24), the method continues at step 20. The device 4 allows detection of modelling errors of the first model M1 and the second model M2 to avoid catastrophic failures or unnecessary maintenance and production stops due to misclassification of spectral lines.

Automatic detection runs during normal operation and allows to preserve machine up-time.

The statistical and model-based hypothesis testing of the frequencies of the significant spectral lines allow using of all available machine and environment knowledge for a systematic and comprehensive search.

A similar corresponding manual analysis would be cumbersome, particularly on complex machines.

What is claimed is:

1. A method for monitoring a first model of a rotating machine including a plurality of rotating parts and a second model of periodic external interferences, the first model comprising a first set of predicted spectral lines and the second model comprising a second set of predicted spectral lines, the method comprising:
measuring vibrations of the rotating machine to deliver a measured vibration signal,
determining the frequency spectrum of the measured vibration signal, the frequency spectrum comprising a plurality of spectral lines,
selecting spectral lines from the plurality of spectral lines according to a predetermined selection rule, the selected spectral lines being significant spectral lines,
determining the significant spectral lines which are not included in the first set of predicted spectral lines and in the second set of predicted spectral lines, the determined significant spectral lines being unidentified spectral lines,
determining the waveform power of each unidentified spectral line,
comparing the determined power of each unidentified spectral line to a power threshold, and
triggering an alarm if the determined power of at least one unidentified spectral line is equal to or bigger than the power threshold.

2. The method according to claim 1, wherein determining the frequency spectrum of the measured vibration signal comprises performing a nonparametric method of spectral analysis or a parametric method of spectral analysis.

3. The method according to claim 1, wherein the predetermined selection rule comprises a model-order selection rule.

4. The method according to claim 1, wherein determining the significant spectral lines which are not included in the first set of predicted spectral lines and in the second set of predicted spectral lines comprises:
for each significant spectral line and each rotating part and each periodic external interference, determining a likelihood function from the first model and the second model of the frequencies generated by the said rotating part in rotation and the frequencies of the second set of predicted spectral lines,
for each likelihood function, evaluating the said likelihood function at the frequency of each significant spectral line to obtain a likelihood probability under frequencies generated by the said rotating part in rotation and frequencies of the periodic external interferences,
for each likelihood probability, comparing the said likelihood probability to a classifying threshold,
when the said likelihood probability is smaller than the classifying threshold, the said significant spectral line is determined not to be included in the first set of predicted spectral lines and in the second set of predicted spectral lines.

5. The method according to claim 4, wherein when the likelihood probability is equal to or bigger than the classifying threshold, the said significant spectral line is assumed to be included in the first set of predicted spectral lines or in the second set of predicted spectral lines, the first and second models are assumed to be reliable.

6. The method according to claim 1, when for a rotating part, a prior probability that the frequencies generated by the said rotating part in rotation are included in the measured vibration signal is known and a prior probability that the frequencies of the second set of predicted spectral lines are included in the measured vibration signal is known, determining the significant spectral lines which are not included in the first set of predicted spectral lines and in the second set of predicted spectral lines comprises:
for each significant spectral line and each rotating part and each periodic external interference, determining a likelihood function from the first model and second model of the frequencies generated by the said rotating part in rotation and the frequencies of the second set of predicted spectral lines,
for each likelihood function, evaluating the said likelihood function at the frequency of each significant spectral line to obtain a likelihood probability under frequencies generated by the said rotating part in rotation or frequencies of the periodic external interferences,
determining a first probability that the frequency of the said significant spectral line is included in the measured vibration signal,
for each likelihood probability, determining a posterior probability of the frequency generated by the said rotating part in rotation under the frequency of the said significant spectral line or the frequencies of the second set of predicted spectral lines, the posterior probability being equal to the said likelihood probability multiplied by the prior probability, the product of the multiplication being divided by the first probability.
when the posterior probability is smaller than the classifying threshold, the said significant spectral line is determined not be included in the first set of predicted spectral lines and in the second set of predicted spectral lines.

7. The method according to claim 6, wherein when the posterior probability is equal to or bigger than the classifying threshold, the said significant spectral line is assumed to be included in the first set of predicted spectral lines or in the second set of predicted spectral lines, the first and second models are assumed to be reliable.

8. The method according to claim 4, wherein the likelihood function is a Gaussian mixture model having its modes centered at the frequencies generated by the said rotating part in rotation or a periodic external interference.

9. The method according to claim 2, wherein the predetermined selection rule comprises a model-order selection rule.

10. The method according to claim 9, wherein determining the significant spectral lines which are not included in the first set of predicted spectral lines and in the second set of predicted spectral lines comprises:
for each significant spectral line and each rotating part and each periodic external interference, determining a likelihood function from the first model and the second model of the frequencies generated by the said rotating part in rotation and the frequencies of the second set of predicted spectral lines,
for each likelihood function, evaluating the said likelihood function at the frequency of each significant spectral line to obtain a likelihood probability under frequencies generated by the said rotating part in rotation and frequencies of the periodic external interferences,
for each likelihood probability, comparing the said likelihood probability to a classifying threshold,
when the said likelihood probability is smaller than the classifying threshold, the said significant spectral line is determined not to be included in the first set of predicted spectral lines and in the second set of predicted spectral lines.

11. The method according to claim 10, wherein when the likelihood probability is equal to or bigger than the classifying threshold, the said significant spectral line is assumed to be included in the first set of predicted spectral lines or in the second set of predicted spectral lines, the first and second models are assumed to be reliable.

12. The method according to claim 9, when for a rotating part, a prior probability that the frequencies generated by the said rotating part in rotation are included in the measured vibration signal is known and a prior probability that the frequencies of the second set of predicted spectral lines are included in the measured vibration signal is known, determining the significant spectral lines which are not included in the first set of predicted spectral lines and in the second set of predicted spectral lines comprises:
for each significant spectral line and each rotating part and each periodic external interference, determining a likelihood function from the first model and second model of the frequencies generated by the said rotating part in rotation and the frequencies of the second set of predicted spectral lines,
for each likelihood function, evaluating the said likelihood function at the frequency of each significant spectral line to obtain a likelihood probability under frequencies generated by the said rotating part in rotation or frequencies of the periodic external interferences,
determining a first probability that the frequency of the said significant spectral line is included in the measured vibration signal,
for each likelihood probability, determining a posterior probability of the frequency generated by the said rotating part in rotation under the frequency of the said significant spectral line or the frequencies of the second set of predicted spectral lines, the posterior probability being equal to the said likelihood probability multiplied by the prior probability, the product of the multiplication being divided by the first probability.
when the posterior probability is smaller than the classifying threshold, the said significant spectral line is determined not be included in the first set of predicted spectral lines and in the second set of predicted spectral lines.

13. The method according to claim 12, wherein when the posterior probability is equal to or bigger than the classifying threshold, the said significant spectral line is assumed to be included in the first set of predicted spectral lines or in the second set of predicted spectral lines, the first and second models are assumed to be reliable.

14. The method according to claim 13, wherein the likelihood function is a Gaussian mixture model having its modes centered at the frequencies generated by the said rotating part in rotation or a periodic external interference.

15. A device for monitoring a first model of a rotating machine including a plurality of rotating parts and a second model of periodic external interferences, the first model comprising a first set of predicted spectral lines and the second model comprising a second set of predicted spectral lines, the device comprising:
first determining means configured to determine the frequency spectrum of a measured vibration signal, the frequency spectrum comprising a plurality of spectral lines, the measured vibration signal comprising measured vibrations of the rotating machine,
selecting means configured to select spectral lines from the plurality of spectral lines according to a predetermined selection rule, the selected spectral lines being significant spectral lines,
second determining means configured to determine the significant spectral lines which are not included in the first set of predicted spectral lines and in the second set of predicted spectral lines, the determined significant spectral lines being unidentified spectral lines,
third determining means configured to determine the waveform power of each unidentified spectral line,
comparing means configured to compare the determined power of each unidentified spectral line to a power threshold, and
actuation means configured to trigger an alarm if the determined power of at least one unidentified spectral line is equal to or bigger than the power threshold.

16. A system comprising:
a rotating machine including a plurality of rotating parts;
measuring means configured to measure vibrations of the rotating machine and to deliver a measured vibration signal;
a first model of the rotating machine including a plurality of rotating parts, the first model comprising a first set of predicted spectral lines;
a second model of periodic external interferences, the second model comprising a second set of predicted spectral lines; and
a device according to claim 15 connected to the measuring means.
